(19) United States
(12) Patent Application Publication
(10) Pub. No.: US 2004/0178623 A1
(43) Pub. Date: Sep. 16, 2004

(54) Means for search of pages in a book

(76) Inventor: Anatoly Mikhailovich Dotsenko, Kiev (UA)

Correspondence Address: Anatoly Dotsenko, c/o Valentina Travnikova, 10310 Song Sparrow Court, Las Vegas, NV, 89135, US

(21) Appl. No.: 10/386,986

(22) Filed: Mar. 11, 2003

(51) Int. Cl. B42F 21/00

(52) U.S. Cl. 283/38

(57) ABSTRACT

A means for search of pages in a book includes data carriers being visible when the book is closed and associated with pages of said book, and textual identifiers of contents of records of identical type of pages of sheets or spreads which consist of non-empty multitude of labels hierarchically ordered and placed over the said carriers each of at least one grapheme. To increase compactness and accuracy of identification, in the structure of the said means each label, except the first label, contains at least one grapheme which distinguishes the textual identifier of a current marked sheet from the textual identifier of the previous marked sheet; each textual identifier contains initial and final label, highlighted by a suitable means; the initial label of each textual identifier is placed over data carrier associated with that sheet of the book where the text record begins with the said label; the final label of each textual identifier is placed over the data carrier associated with that sheet of the book where the text record begins with the said identifier; position of each label in hierarchy of labels of each current textual identifier is highlighted by at least one of suitable means; and labels of identical hierarchical rank in adjacent textual identifiers are highlighted by identical suitable means.

### TECHNICAL FIELD

The present invention relates to a structure of a means for fast search of relevant pages in such books, which are mostly reference books. The most known examples of them are:

dictionaries, preferably bilingual, including hieroglyphic and key dictionaries;

telephone directories, address books, guide-books;

directories of firms, commodities and services;

reference books like “Who is Who”, “Yellow pages”, “Kompass”;

trade catalogues, price lists;

reference textbooks, identifiers, atlases;

commercial publications (in particular, user's guides of any hardware and software);

indexes of scientific references like “Science Citation Index (SCI)”, “Current Contents (CC)”;

encyclopedias and, especially, encyclopedic dictionaries;

classifiers, like IPC—International Patent Classification, ICGS—International Classification of Goods and Services, and, especially, alphabetic subject indexes to them, etc., etc.

### BACKGROUND OF THE INVENTION

It is well known that reference books users waste bulk of time to select pages bearing relevant textual records. Therefore it is very desirable that the books should be supplied with simple, comfortable and popular means for as possibly more fast and exact searching of pages.

In such a means to make easier the search of pages, there are usually standard textual and/or non-textual means for identification of the contents of a book.

A detailed list of them is specified in a book by Adamov E. B., Krichevsky V. G. Reference Books Designing, Moscow, “BOOK [KNIGA]”, 1981, ( [symbol] , [symbol] [symbol] [symbol] [symbol] .—M., “ [symbol] ⇄, 1981), see pp. 33-45 and corresponding illustrations.

A textual means of identification always reflect in compressed view (and in particular, in abbreviated) the contents of records of text of entries on books' pages. These means are built of graphemes, i.e. of separate symbols of arbitrary alphabet, (characters, letters), digits, (figures, ciphers), hieroglyphs, braille and other simplest signs. Of non-empty multitudes of graphemes the labels are formed, and inside them separate graphemes occupy definite positions, while out of non-empty multitudes of well ordered labels textual identifiers are formed which are having in essence a form of separately represented highlighted parts of records of texts on appropriate pages.

In simplest cases a label can consist of the only grapheme, and textual identifier can include the only label. Herewith it is important to distinguish records of texts on pages and, fields of records of these texts from records of textual identifiers and fields of records of labels in such identifiers.

It is evident that, the degree of accuracy of pages' identification is in direct dependence from volume of reflection of pages' contents in records of textual identifiers chosen for review and that, the more full will be such records, the more space can be needed for their placing.

Examples of such combination of textual identification means as “contents list—page numbers” are known to any reader. Contents list has usually a form of thesaurus placed at the very beginning or at the end of a book i.e. it is a list of the book parts ordered by contents. This allows to represent in detail the contents of book because the length of headlines records of parts, chapters, paragraphs and another possible entries can be very large and is limited only by common sense.

Naturally, the search based on the contents list allows to determine only the initial and final page numbers of relevant parts of books, but specific data have to be searched for by continuous studying of pages within detected intervals of page numbers.

However in reference books, systems usually artificial, alphabetic, as a rule, for data structuring are used to organize text. Therefore in them for contents representation instead of practically useless scheme. “contents: list-page numbers”, other well known scheme “index-page numbers” can be used. An index is usually an alphabetical list of key terms pointing to page numbers, being placed as a rule at the end of one-volume books or in the last volume of multi-volume reference books.

While using such a means it is possible to provide exact finding of relevant information. But even infrequent appeals to index with next searching of necessary pages by primitive thumbing of pages quite weary readers. Therefore “index-page number” scheme is usually applied in multi-volume one-language explanatory and encyclopedic dictionaries, which are mainly seldom used for asking questions.

For bilingual dictionaries or telephone directories, predominant in mass of the reference books, which by themselves are “alphabetical indexes”, above mentioned scheme is needless.

In such books as a rule, the running titles serve as textual identifiers of contents. Usually they have a form of records of initial or final parts of text on definite pages or sides of sheets or spreads (or U-turns, adjacent pages, openings, double-pages etc.) of books, abbreviated up to two-three initial letters (also called catchwords) placed at margins of pages.

Since the catchwords are not visible when the book is closed, their use for searching of needed page still demands practically the entire examination. Herewith it takes usually not less than one minute per one reference and, during translation of foreign text, the lion's share of time has to be wasted for thumbing of dictionaries.

Among the non-textual means of search there are:

cuts in sheets that can be different in form (rounded, rectangular etc.) and in position relative to book edge (straight, including: sectional or direct; or with slant);

tabs (flags, juts, ledges, stickers, tags, etc., etc.) of sheets;

half-titles (i.e. rigid insertions or insets between book sections of different contents);

usually colored plates (markers) near the edge that run to the edge of the sheet (bled, leaving no margin) and can thus be seen on the edge of the closed book, which enable to distinguish by eye, book parts of different contents;

variable size of sheets;

bibliochrome i.e. printing of each block of pages of the same type of contents on paper of its own color, it is often used at issuing of telephone directories and trade catalogues,

identical color-code marks not visible on edge, placed on margins of pages of identical type of contents.

With acquired skills, non-textual means partly simplify orientation of readers in searching by them of necessary pages. Therefore some users themselves add some of such a means to their own dictionaries and reference books.

In practice in overwhelming majority, the means for quick search of pages in a book are some kind of combinations of textual and non-textual means. In these combinations some non-textual means serve as data carriers being associated with book sheets and more specifically as carriers of records of textual identifiers.

The means for search of pages in a books, mainly in dictionaries, being known from 67904 A1(1948) can serve as an exotic example of such a combination of textual and non-textual means. Its textual identifiers include labels of two types:

a) the initial alphabet letters by which entries of each group of sheets are marked and which are placed in the middle of such groups on tabs or under cuts so, that they are visible to user when the book is closed;

b) the second, third, and sometimes fourth letters of words specified on appropriate page; the said letters are placed on margins near edge of these pages and are inaccessible to user, when the book is closed

However while using such a means, the growth of accuracy of finding of page (supposed by inventive conception) leads toward difficulty and slowing down of procedure of searching.

Therefore in practice far more often such popular combinations of textual and non-textual means are used as:

stair-step cuts in sheets of dictionaries or telephone directories, which reach the first pages with certain next in turn alphabet-letters; and letters as identifiers (thumb-indexes) visible on appropriate ledges of the closed book;

tabs visible at a closed book, which are associated with those pages of dictionaries, telephone directories or trade catalogues, where the words, entries or the records devoted to definite classes of commodity starting with some symbol of alphabet, are appearing for the first time; and proper literal or other symbolic identifiers shown on such tabs.

These combinations of the said primitive textual and the simplest standard non-textual means cannot ensure identification of each separate page, when the book is closed. In fact, the informational capacity of the majority of reference books is so great, that the cuts or tabs on all sheets prevent perception of the contents even of short (up to two graphemes) textual identifiers, and for detailed identifiers containing more than two graphemes, simply there is no place.

For example in the description of background of the invention, in U.S. Pat. No. 4,978,143 there is a review of a lot of unsuccessful attempts to create a compact and reliable means, capacious for information which are comfortable in use for access to pages and need no thumbing through pages, mainly for such bulky and frequently quoted books as Bible.

A means for search of pages in dictionaries as in U.S. Pat. Nos. 5,306,048 and 5,624,138 may serve as the examples of more successful combined attempts. Non-textual parts of these means are represented at the edge by bleed plates polychromatic or monochromatic with differing by background saturation. Herewith in U.S. Pat. No. 5,624,138 for dictionaries with European alphabets there are:

a) relatively larger plates defining current first letters of alphabet; and

b) relatively smaller plates defining the second letters of alphabet within the interval of pages limited by plates of the first type.

The plates of the said two types correspond to symbols of the first and second syllables if they are applied to Japanese syllables alphabets, symbols of which can be represented by letter or letters of Latin alphabet.

Accordingly, there are plates of the first and of the second types on margins of each page within proper “alphabetic interval” and they are located bleed at book edge separately so, that it is possible to distinguish, when the book is closed, the large intervals of pages corresponding to the first letter only, and within the said intervals the smaller intervals of pages, which correspond to pairs of letters.

In any embodiment of the said invention the labels of one or two graphemes which are placed on the edge and duplicated inside of bleed plates on the margins of pages serve as textual means of identification of proper pages.

Using such means, readers, while book is closed, concatenate successively labels located on the edge over butts of plates or nearby of plates of first and second types, into textual identifiers, then open the book to check out correctness of coincidence of other parts of textual identifiers. Such verification is inescapable, even for labels having only two graphemes which can be placed with difficulty on book edge nearby or over visible area of the plate of lesser size. Practically it is impossible to show on the edge of book the thirds, fourth etc. graphemes for more exact identification of pages.

Therefore accuracy of such identification of relevant pages of closed book is not high.

A means for search of pages in a book according to U.S. Pat. No. 4,927,178 by technical essence is the nearest to the offered one. It has:

a) data carriers associated with the book sheets and visible when the book is closed, including:

front sheet which

precedes sheets bearing the vocabulary entries,

has a form of flat table that consists of horizontal rows and vertical columns and

is visible to reader if this sheet serves as cover or if the book is opened on it; and

slanting fore-edge (so, that each next page is a little wider than a previous one) with raster table of horizontal rows and of almost vertical columns visible to reader when the book is closed placed over it;

b) textual identifiers of contents of entries of the identical type of sides (of right or left pages) of sheets or spreads, which are placed over data carriers and consist of non-empty multitude of hierarchically ordered labels and, more specifically, consist of literal labels placed in rows in table cells (in original—in “zones”) on front sheet and contain at least one grapheme but preferably up to four graphemes;

c) additional digital labels from 1 to n (where in particular, n=7), by means of which the cells of each row of the table on front sheet are numbered one by one, some of digital labels, e.g. the even ones being indicated in corresponding cells of some rows of the table on slanting fore-edge; and

d) additional literal indexes which are located on front sheet before beginning of each row of table and correspond in proper rows to the first letters of textual identifiers of contents of pages. Such indexes often consist of one letter, usually identical for several rows, but can also be of two and more letters depending on dictionary capacity and the use frequency of corresponding letters in beginnings of words.

According to inventive intention, amount of textual identifiers of pages' contents, and accordingly, the number of cells for inserting them into the table on front sheet in described means must at least correspond to a quantity of pairs of adjacent pages of reference book.

However such means can be effectively used only in books with relatively small amount of sheets. Indeed, for reference books and dictionaries of large capacity even on a big front sheet of “encyclopedic” size, it is impossible to place a table with sufficient amount of easily distinguishable textual identifiers. Therefore it needs or to sacrifice accuracy of identification of pages or to divide the book with rigid half-titles to place tables with different sets of textual identifiers consistently complementing one another.

### BRIEF DISCLOSURE OF THE INVENTION

The basic object of the invention is, by means of improving of fulfillment of form and mutual disposition of labels in textual identifiers and interrelation of the said labels among themselves and with data carriers associated with the book sheets, to create a means for search of pages in a book so that, at viewing of the closed book irrespective of its capacity and format, they would secure the rising of accuracy of identification of separate pages with reducing the needed space for the data carriers.

The specified object is solved by dint of a means for search of pages in a book, which has:

data carriers being visible when the book is closed and associated with pages of said book, and

textual identifiers of contents of records of identical type of pages of sheets or spreads which consist of non-empty multitude of labels hierarchically ordered and placed over the said carriers each of at least one grapheme,

according to the invention

in the structure of the said means,

each label, except the first label, contains at least one grapheme which distinguishes the textual identifier of a current marked sheet from the textual identifier of the previous marked sheet;

each textual identifier contains initial and final label, highlighted by a suitable means;

the initial label of each textual identifier is placed over data carrier associated with that sheet of the book where the text record begins with the said label;

the final label of each textual identifier is placed over the data carrier associated with that sheet of the book where the text record begins with the said identifier;

position of each label in hierarchy of labels of each current textual identifier is highlighted by at least one of suitable means; and

labels of identical hierarchical rank in adjacent textual identifiers are highlighted by identical suitable means.

In a described means, labels of several successive textual identifiers, practically do not repeat one another, because they differ by graphemes and by position in hierarchy. Herewith each textual identifier which contains more than one highlighted (i.e. differential) label is dismembered so, that separate labels are placed over different data carriers visible when the book is closed and being associated each also with different sheets of the book. Or else:

each label is highlighted among all others because each label ends one textual identifier, which conforms to a book sheet marked by this label and just it binds concrete textual identifier to a concrete sheet;

each sheet is highlighted (i.e. marked) among all of other sheets by the only label which is placed over data carriers and associated with given sheet;

even in very thick reference books, each label associates a unique textual identifier with its own sheet.

Consequently:

a possibility arises, to use for identification of pages considerably longer and thus of more informative parts of key words of entries and usually whole key words, but not of their stumps of two or three letters, how this is usually adopted for the catchwords of bilingual dictionaries and telephone directories; and

a problem of free placing of such long textual identifiers is practically solved.

Because the first and last label of each textual identifier are highlighted by means accessible for visual or tactile perception, this does not demand excessive efforts from readers to concatenate a few labels into holistic textual identifiers.

The first additional difference means that the suitable means for highlighting labels is an easily distinguishable by eye or by skin textual or non-textual means selected from a group which consists of:

allographs of graphemes used in structure of labels;

a color, or saturation of color of graphemes, used in structure of labels;

full or partial frame around the separate graphemes inside the labels and/or around the separate labels as a whole;

position of separate grapheme in structure of labels and/or separate label in the structure of the textual identifiers;

numeration of hierarchical positions (ranks) of separate labels in a structure of textual identifiers;

a color or saturation of color or of a geometrical form or texture of the data carriers, associated with sheets of the book; and

arbitrary combinations of at least two specified means.

The above-mentioned term “allograph” here and further is applied in its standard sense for a designation of such identical in essence but externally different forms of patterns of the characters, letters, ciphers, hieroglyphs or other graphemes, by which reliable visual or tactile identification of each separate grapheme is ensured. As the simplest examples of allographs can serve:

letters of different size of upper-case and lower-case;

letters and digits of different standard and non-standard (artistic) fonts, that differ by geometric form of contours, by dimensions, by lines thickness, by directions and corners of slope, by elements of ornament etc. etc.

Using of allographs for highlighting the differential labels in a means for search of pages in a book, according to the invention, provides the cheapest and simplest realization of invention concept. Thus it is especially expedient in such mass reference books which or are intended for broad range of readers like cheap bilingual dictionaries or must be regularly updated like telephone reference books and trade catalogues.

In more expensive commercial and/or exclusive reference books of long-duration use of a type of encyclopedias it is preferable to use in accordance to the invention such a means in which the differential labels are highlighted by various color or fluctuation of saturation of color of graphemes and by full or partial frame of separate graphemes and/or of separate labels.

However in case of manufacturing of a means according to the invention for improvement of books, issued earlier the use of specified color means for highlighting labels, by moderate price and simplicity would be quite able to compete with the using of monochrome allographs.

Special positioning of separate graphemes in a structure of labels of textual identifiers is the most expedient if there are sufficient space of data carriers being associated with sheets of a book, or for rare, alternate, or of incremental use (for example, in a structure of labels being far away from initial labels in hierarchy).

Special positioning of separate mainly of initial differential labels in a structure of textual identifiers is the most advisable for fast selection by eye or by hand of current sections in reference books, which can be organized in systematic or formal, in particular, in alphabetic, key or chronological order, as it is usual for example in the catalogues of exhibitions devoted to multitude of diverse themes and/or goods.

The numerations of hierarchical ranks of labels can serve as most universal means of their highlighting (of differentiation) in a structure of textual identifiers. It makes especially obvious to anyone even to unskilled user of reference books one of the invention essence aspects, of providing of highlighting by same type of means, of labels of same type (i.e. of the same hierarchical level). However the numeration requires an increase of the area of data carriers being associated with sheets of the book. Therefore it is desirable to use the said means in the reference books for pupils and students.

Such a non-textual means, as color, or saturation of color, or geometric form, or texture of data carriers being associated with sheets of books, are especially desirable for highlighting (differentiation) of initial labels in a structure of textual identifiers, since these labels are usually common for a tree of textual identifiers of many subsequent sheets. Therefore, despite possible rise in price of reference books equipped with specified means of highlighting of labels their practical use is very desirable, especially in the advertising catalogues.

The data carriers textures recognizable by touch occupy exclusive place among non-textual means of labels highlighting, since these are usable in books for blind.

And at last, from a number of arbitrary combinations at least of two specified means of labels highlighting (of differentiation), the most preferable combinations are:

firstly, use of at least one upper-case allograph in initial labels of textual identifiers, which are in addition highlighted in whole by color of graphemes or of background, that simplifies visual orientation in a means in obedience to the invention and also search of necessary pages;

secondly, use of at least one upper-case allograph in initial labels of textual identifiers, in a combination with partial or complete frame of such labels, that also simplifies visual orientation in a means in obedience to the invention and, the search of necessary pages;

thirdly, combination of positioning of separate graphemes in structure of labels and numeration of separate labels in structure of textual identifiers provides the simplest orientation in a means in obedience to the invention and, the search of necessary pages.

The second additional difference means that the data carriers, associated with the book sheets, are selected from a group consisting of:

a) parts of the book sheets which are free from main text and are:

margins of pages being at least partially visible to user while bending the sheets; or

butts of sheets at the head, tail, and fore edge of the said book; and

combinations of the said margins and butts of sheets;

b) tabs of suitable form, which are located outside the edge of the book sheets, with labels placed over them and which represent:

either parts of book sheets,

or additional details of suitable material, attachable to the book sheets.

The margins of book sheet which are free from man text can serve as data carriers for placing of entire labels at separate sheets of the book if in previous sheets will be executed cuts to provide viewing of labels at bend of book block.

But it is far more effectively the using of such margins for putting at them of the disappearing raster labels of textual identifiers, which readers can see while curving of at least part of a book block at some angle.

The butts of head, tail, and fore edge of sheets can also serve as basis for raster textual identifiers, but preferable in such a reference books, which have thick thematic sections, and one textual identifier corresponds to each of section.

The use of combinations of specified margins and butts of sheets as data carriers being associated with sheets of the book, practically do solve a problem of space, necessary and sufficient for placing of raster textual identifiers in arbitrary reference books.

The special advantage of such forms of embodiment of a means according to the invention consists in increased endurance to wearing and in fitness to repairing.

Tabs being of suitable form, which are located outside of edge of the book sheets, irrespective of whether they are parts of book sheets or are additional details, can serve as most simple carriers of labels. Really a means according to the invention with such data carriers, without peculiar effort can be designed and produced in conventional industry of printing and publishing. Moreover, a means according to the invention, which consist of details being associated, can be made separately from reference books; and polymeric films, which have endurance to wearing, may be used as a suitable material for such a means.

The third additional difference means that an initial and a final data carriers in the structure of the said means are associated with proper sheets of the book in approximately middle part of edges of these sheets. This difference facilitates access of the readers to the found pages.

The fourth additional difference means that only page margins adjoining to the edges of sheets are used as data carriers and at least two raster labels are put over each of them on different distances from the edge.

These labels can be different or identical. If labels are different, it is possible to use different graphemes (for example, one Latin and at least one of two Japanese syllabic alphabets) for textual identifiers of identical contents. This, in particular, permits to replace one full set of textual identifiers with other by trimming of the sheets in accordance with desire of reader. If labels are identical it is possible to update a full set of worn textual identifiers by similar trimming of the book.

### BRIEF DESCRIPTION OF THE DRAWINGS

Further, essence of the invention is explained with the detailed description of a design and practical use of the offered means for search of pages in a book, with references to enclosed drawings, where:

FIG. 1 is an example of hierarchically ordered literal fragment of a means for search of pages in a closed reference book, (in special variant of realization of inventive concept, with use of tabs as data carriers being associated with sheets of the book);

FIG. 2 is case as on FIG. 1 (in special variant of realization of inventive concept, with use of raster placed over data carriers having a form of pages margins adjoining to edges of sheets and, if it needs, butts (faces of lateral sides) of sheets of the book);

FIG. 3 is same as on FIG. 1, with numbers of hierarchical ranks of literal labels shown at the left side (as an example, a set of labels of textual identifier “Internet” is highlighted by ticks);

FIG. 4 is a scheme of a superposition of literal textual identifiers included in fragments according to FIG. 1-3 and of appropriate records of texts on the identical type of pages of the reference book (for an example there is a frame around word “Internet” being the text record of the book);

FIG. 5 is an example of an hierarchically ordered digital fragment of a means for search of pages in a closed reference book, (in special variant of realization of inventive concept, with use of tabs as data carriers being associated with sheets of the book);

FIG. 6 is case as on FIG. 5 (in special variant of realization of inventive concept, with use of raster placed over data carriers having a form of pages margins adjoining to edges of sheets and, if it needs, butts (faces of lateral or end sides) of sheets of the book);

FIG. 7 is same as on FIG. 5, with numbers of hierarchical ranks of digital labels shown at the left side (as an example, a set of labels of textual identifier “2016” is highlighted by ticks);

FIG. 8 is scheme of a superposition of digital textual identifiers, included in fragments according to FIG. 5-7, with records of page numbers been on the same (even) type of pages of the reference book, which are appropriate to the said identifiers (for an example a record of page-number 2016 has frame around, and a recognition key of the hierarchical ranks of one-digit labels is conditionally put at the top);

FIG. 9 is preferable location of carriers of the initial and final labels of a means for search of pages in a book near middle of edge of the first and last sheet of a book;

FIG. 10 is conditional view of edge of reference book at which labels of textual identifiers are placed on margins of pages only and can be seen through local stair-like cuts in nearby sheets, which are alternated on both sides of sheets;

FIG. 11 is an example of the data carriers in a form of tabs of sheets, which are producing directly on publishers enterprises while printing of books;

FIG. 12 is an example of the data carriers, in a form of tabs made separately to be later associated (to be tied) with sheets of previously printed books;

FIG. 13 is a scheme of preferable mutual stepped (overlapped) disposition of sheets tabs on book edge (a view from butts onto a fragment of a book block);

FIG. 14 is a scheme of a disposition on pages margins of a closed book of raster strips corresponding to parts of two sets of labels of textual identifiers (with conditional thickness of a layer of typographical paint forming the labels);

FIG. 15 is a scheme of view of raster images of labels of textual identifiers while bending of sheets of the closed book shown on FIG. 14;

FIG. 16 is an embodiment in braille of a raster fragment of a means including two textual identifiers of FIG. 3;

FIG. 17 is a fragment of a textual identifier of FIG. 2 for raster variant of realization of inventive concept, with highlighting of an initial label by a frame;

FIG. 18 is same as on FIG. 17, in a three-dimensional view with conditional break of the book sheets;

FIG. 19 is a view of book block, bent under own weight into one (right) side at putting under this block of support or hand of the reader;

FIG. 20 is a view of book block, bent under own weight into one (left) side due to pressing on the backbone close by the book cover;

FIG. 21 is a view of opened book block, bent toward both sides under own weight at putting of support under backbone of the book;

FIG. 22 is a schematic image of general view of the open book with a means in which sheets tabs placed like stair-steps shown conditionally in increased scale serve as data carriers for placing of labels and conditionally in the right part respond to FIG. 1 and in the left part to FIG. 5;

FIG. 23 is a schematic image of general view of the open book with a means in which sheets margins visible at fore-edge of bent book block through local cuts placed like stair-steps in previous sheets shown conditionally in increased scale serve as data carriers for placing of labels and conditionally in the right part respond to FIG. 1 and in the left part to FIG. 5;

FIG. 24 is a schematic image of the general view of the open book with a means where pages margins adjoining to edge of book and, if having a wish, butts of sheets serve as data carriers for placing of raster of labels and conditionally respond in right part to FIG. 1 and in left part to FIG. 5, (herewith the examples of labels are given conditionally in increased scale);

FIG. 25 is a schematic image of general view of the closed book with visible edition imprint of publisher or printer on the spine and with a means for search of pages in a book in a form of rows of data carriers, associated with sheets of book along one of the edges of the book, (herewith the data carriers conditionally are designated by bold lines as running markers of edge index);

FIG. 26 is a means (conditionally shown as “already been assembled”) for search of pages in a book “English-Russian Dictionary” by V. K. Muller (with literal labels);

FIG. 27 is the same as on FIG. 26 (with digital labels).

### DESCRIPTION OF PREFERRED EMBODIMENTS

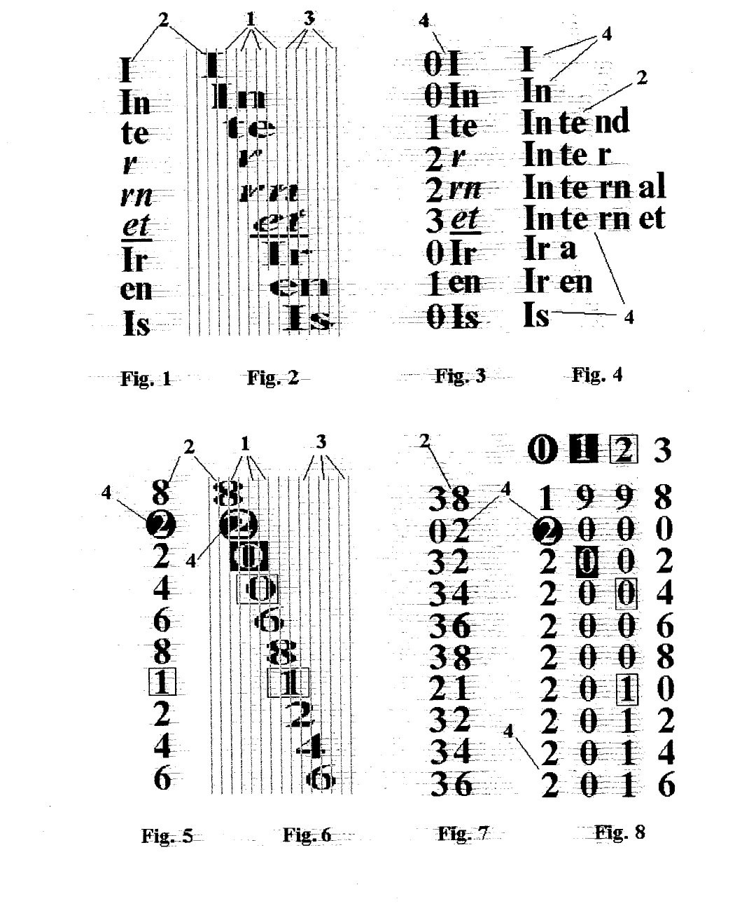

An offered means for search of pages in a book in general case has the following basic parts (see FIG. 1-8):

data carriers 1, being associated with book sheets, and

been placed over such carriers 1 and consisting of at least one grapheme the labels 2 of letters (as on FIG. 14) or of digits (as on FIG. 5-8) of contents of records, located on the same type (left or right) of pages or spreads (accordingly entries, key words, catchwords or page numbers may be as these records).

The data carriers 1 are conditionally designated by shaded background on FIG. 1 and FIG. 5, FIG. 3 and FIG. 7, FIG. 4 and FIG. 8. A general area of each carrier 1 serves by field for record of an appropriate label 2. This area must be sufficient for records of labels 2 of maximum length, chosen beforehand usually inside the limits of from one to three and preferably up to two graphemes.

In reality as data carriers 1 can serve:

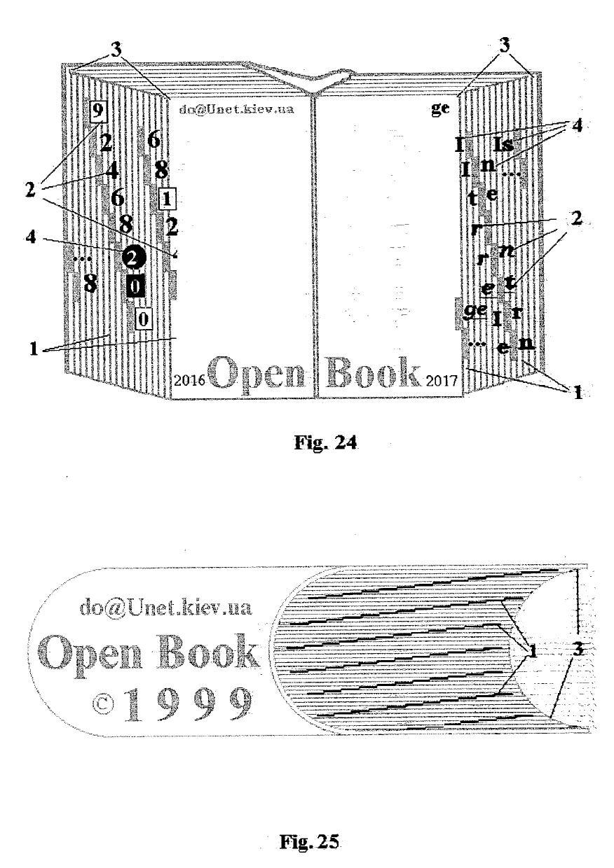

a) for embodiment of inventive concept in raster forms wear-resistant but complicated in manufacturing,—parts of book sheets 3, which are free from main text and (as on FIG. 2 and FIG. 6, FIG. 16, FIG. 17 and FIG. 18 and FIG. 24) have a view:

of margins of pages, which will be at least partially visible to the reader if sheets 3 are bent;

of butts of sheets 3, of a book block at the head, tail, and fore edge; and

of combination of the said margins and butts of sheets 3;

b) for embodiments of a means according to the invention in more simple forms convenient for manufacturing,—tabs of suitable shape (not only of rectangular), which are located outside of edge of book sheets 3 with labels 2 placed over them, and which are:

or parts of book sheets 3, (as shown in preferable form of a means embodiment on FIG. 11);

or they by themselves (as on FIG. 12) present the additional, of suitable material, details being artificially associated for example by glue with the book sheets 3.

By such materials can be firm paper, and preferably transparent or opaque wear-resistant films of polymer materials like a polyvinyl chloride, polypropylene with surface oxidized to improve an adhesive activity, etc.

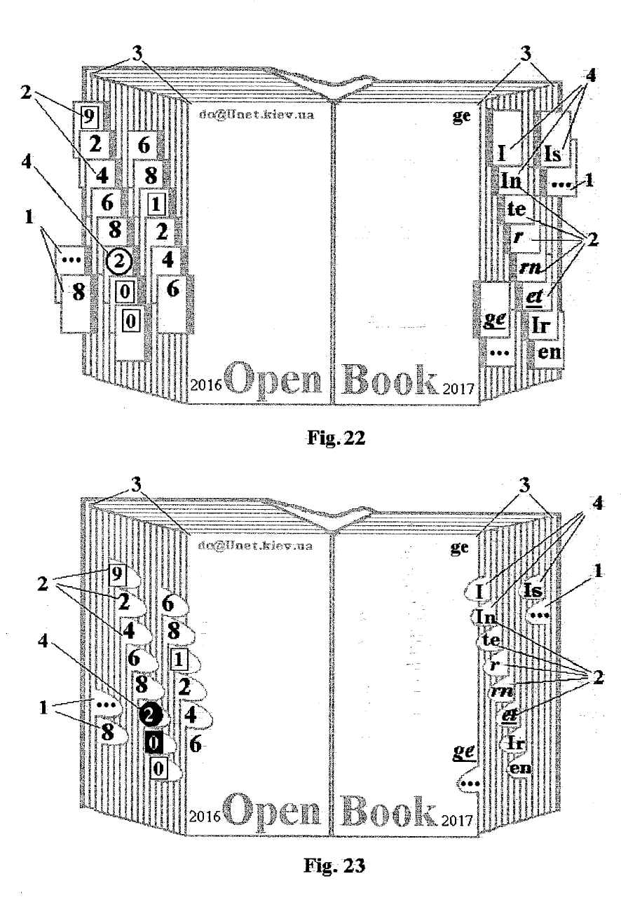

Any data carriers 1, being juts outside of an edge of book block as a whole, give to the books, which are equipped with a means according to the invention, a view as on FIG. 22. For protection of these carriers 1 from casual damage the reference book can have a rigid cover or flap, or more wide cover than sheets 3 with tabs.

To prevent need for such protection, tabs as parts of sheets 3, of books can be located inside the book block, but outside of local edges of previous sheets (located under cuts), as shown on FIG. 10. In this case the labels 2 will be placed at margins of pages and can be visible at a bend of a book block through the said alternated cuts in sheets 3, as shown on FIG. 23.

The raster form of realization of the invention practically eliminates a question of protection of labels 2 from wear. So, if in a means at least two identical raster labels 2 are placed on each of pages' margins adjoining to edge of sheets 3, on different distances from the edge, which serve as data carriers 1, as shown on FIG. 14, then it is possible to remove at once a whole set of worn textual identifiers 4 on edge, by a simple trimming of sheets 3.

The same trick of duplication of raster labels 2, allows to use different graphemes, in particular, of Latin alphabet and at least of one of two Japanese syllabaries (kana), in textual identifiers 4, of identical contents. In this case by very similar trimming of sheets 3, at the request of the reader it is possible to replace one whole set of textual identifiers 4, by another.

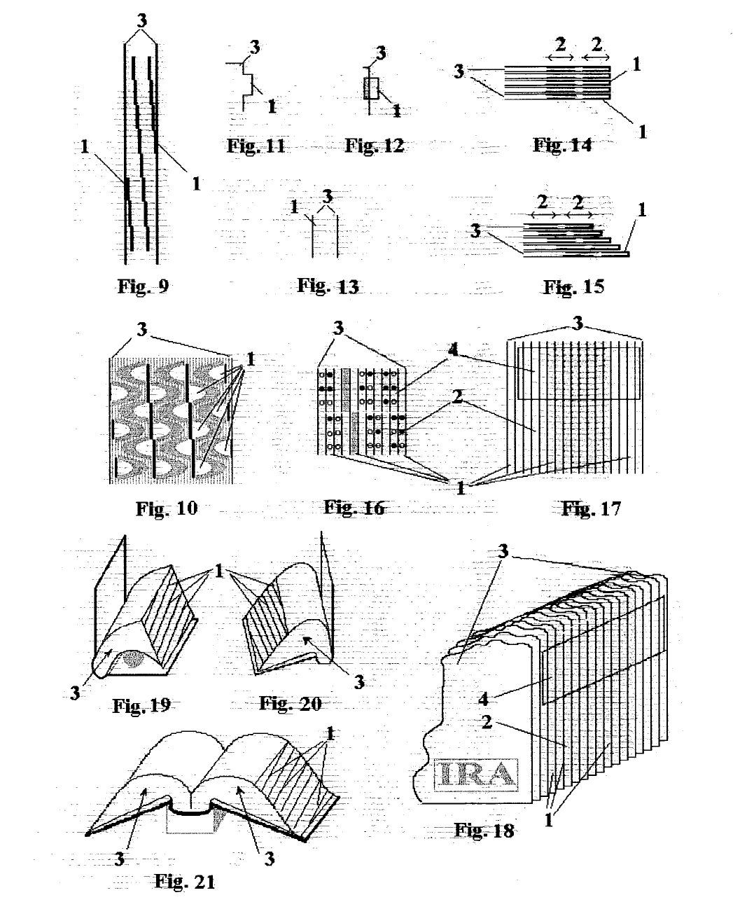

Expediently also (see FIG. 9) in a means fulfilled as shown on FIG. 11 or FIG. 12 in obedience to the invention, to associate the initial and final data carriers 1, with appropriate book sheets 3 near mean part of edges of the sheets 3.

For lucidity of understanding of these particular variants of embodiments of the inventive concept, sheets 3 with tabs being outside of edge or, sheets 3 with labels 2 on margins of pages, on FIGS. 9 and 10 are conditionally shown by bold lines.

Irrespective of form of embodiment of the invention, data carriers 1 with the labels 2 placed over them, should be located so that at closed book by a simple bend of book block it was possible to provide reading of textual identifiers 4 (see for example FIG. 4 and FIG. 8.) Each textual identifier 4 by itself is a non-empty multitude of hierarchically ordered labels 2 which points onto definite page of definite sheet 3, or the spread. For implementation of these conditions:

in the structure of a specified means, each label 2, except initial, contains at least one grapheme which differentiates a textual identifier 4, of marked current sheet 3 from a textual identifier 4, of marked previous sheet 3;

each textual identifier 4, contains the first and the last label 2, highlighted by further specified suitable means;

the first label 2, of each textual identifier 4, is put on data carrier 1, being associated with that sheet 3, of a book where entry or record of text of the book begins with such a label 2;

the last label 2, of each textual identifier 4, is put on data carrier 1, being associated with that sheet 3, of a book, where entry or record of text of the book begins with such a textual identifier 4;

position of each label 2, in hierarchy of labels of each current textual identifier 4, is highlighted by at least one of further specified suitable means, and

the labels 2, of identical hierarchical rank in adjacent textual identifiers 4, are highlighted by identical means.

The whole complex of these conditions will be executed even when some textual identifier 4 consists of the only label 2 and this label 2 consists of the only grapheme (for example the literal identifier 4 “I” on FIG. 1-4 and as well the digital identifier 4 “2” on FIG. 5-8).

However the textual identifiers 4 can be considerably longer than labels 2 included in them and consist of up to 10 and of more graphemes. Herewith choice of such length of textual identifiers 4 which is sufficient for recognition of texts records contents, on separate pages, is predetermined just by these contents, but not by such geometrical and other parameters of book, as format, amount and thickness of sheets 3, or sizes of margins on pages etc.

From examples shown on FIG. 1-8 it is clearly that in essence all labels 2 are highlighted, because they are put over different data carriers 1, and that those textual identifiers 4, which contain more than one label 2, are by themselves thesauri.

It should keep in mind, that the graphemes, shown on FIG. 4 and FIG. 8 on a white background are not the labels, although they are parts of holistic key words or page numbers, which are present in records of text of the book. These graphemes are not placed over data carriers 1 being associated with book sheets 3, they are indicated only for visual representation of way of perusal of textual identifiers 4 like thesauri.

Various textual or non-textual means, easily distinguishable by naked eye or by the touch, can be used for highlighting labels 2.

By examples of textual means of highlighting of labels 2 can be:

allographs of graphemes, used in structure of labels (as shown, in particular, on FIG. 1-4 upper-case and lower-case letters of the Latin alphabet), and

shown at the leftmost columns on FIG. 3 and FIG. 7, numbers of hierarchical ranks of separate labels 2 in a structure of textual identifiers 4.

Of course, represented examples by no means limit the opportunity to use other allographs and other means of a designation of hierarchical ranks. In particular, preferably the first letters of various alphabets other than alphabet for records of labels 2 can be as such a means of ranking.

By non-textual means of highlighting of labels 2 can be:

color or saturation of color of graphemes, used in structure of labels 2;

full (see FIG. 17-18) or fragmentary (for example, by underlining as on FIG. 1-3) framing of separate graphemes inside the labels 2 and/or separate labels 2 as a whole;

a positioning of separate graphemes in structure of labels 2, and/or of separate labels 2, in structure of textual identifiers 4, as shown visually for example on FIG. 2 and FIG. 6, where the bold lines in front of letters and behind the digits, serve as markers to tie up or to associate definite raster label 2, with the definite sheet 3, of book;

color or saturation of color or geometrical form or texture of data carriers 1 being associated with book sheets 3.

Naturally, in practice, to highlight labels 2 in a means according to the invention, any combinations at least of two of specified textual and/or non-textual means can be used.

It's also natural that other suitable markers can be used for associating of the raster label 2, to particular sheets 3, of a book instead of shown bold lines which, by the way not necessarily ought to be equal to graphemes by height or exclusively to precede graphemes.

Color spots, including different color of separate vertical parts of graphemes (for able to see) and local modifications of texture of sheets 3, (for the blind) can be such examples of simplest markers.

A special example of such a marking for blind is shown on FIG. 16, where two raster labels 2, “0Ir” and “1en”, from example FIG. 3 are visible. Each of these labels 2 consists of three graphemes, blank spaces and of a marker, namely:

of a digit, which gives an hierarchical rank for each label 2, in the identifier 4;

of a marker; and

of two letters.

All graphemes are executed in standard Braille code of six points, as example by embossed raised dot font on margins of a number of sheets, with blank sheets (as spaces with no embossing) for convenience of recognition of digits and letters by the blind readers.

Herewith rough margins can be as markers of sheets 3. For convenience of perception of an example of FIG. 16 the first literal grapheme “I” in a label “0Ir” and digital grapheme “1” and both of literal graphemes “e” and “n” in a label “1en” on the drawing are framed, and butts of sheets 3 are conditionally shown by continuous vertical lines.

Principles and example of calculation of need in space for data carriers 1, being associated with book sheets 3 are introduced further. In these principles, there was taken into account, that despite permanency of height of a visible edge of a book, its width can be considerably increased, by a bend of a book block as shown on FIG. 19-24, particularly, in variant of placing of raster labels 2, on a book fore-edge, which is located opposite to spine (backbone). However, it should not exclude an opportunity of placing of carriers 1 and on other edges of a book.

By source data for computations serve:

firstly, the book parameters' values which are given by a book designer and which designers of a means according to the invention accept as a constant initial data, namely:

P—amount of a book sheets, by one unit more than amount of spreads;

H—height of sheet or fore-edge of a book (as applied to which all of calculation formulas are given further, for the sake of simplification);

L—width of a sheet, or a length of head, and tail edges of a book;

D—thickness of a sheet;

secondly, the values of parameters, which are directly conditioned by said source data and influence choice of raster or other variant of embodiment of inventive concept, namely:

V=P*D—Minimum visible width of butt of a fore-edge of a closed unbent book, of 42 mm for the further described example of “English-Russian Dictionary”, and

W>V—conditioned by methods and means of bending, width of a fore-edge visible when the book is closed and being reached in the said example of dictionary after bending of a book block, including a width of adjoining to edges of pages margins and butts of sheets:

W₁≈110 mm (about 262% of V)—while bending at an angle a little more than 90° preferably with use of prop (like a small tennis-ball for example) under sheets, as on FIG. 19, or

W₁≈160 mm (about 380% of V)—while bending of sheets on an angle of up to 180° manually, for example, by pressing on a spine (backbone) of a book block, as on FIG. 20, or by support under a spine, as on FIG. 21.

thirdly, the values of parameters, which in view of mentioned source data and values of V and W can be chosen or calculated by the designers of specified a means on the basis of the general recommendations and/or a common sense, namely:

h—minimum height of fields of labels 2, which should be not less than height of upper-case letters of a font, chosen for these labels;

m—width of a widest letter of a font chosen for labels 2;

l—maximum quantity of graphemes in labels 2 (preferably no more than three and the most preferably, no more than two);

v≧m*l—minimum width of fields for placing of graphemes of labels 2 on data carriers 1 in a form of tabs, or of margins near edge under cuts, or of only butts of several sheets 3 located in succession, in a closed unbent book (this width is designated by shade of background on FIG. 1, FIG. 3-5, FIG. 7 and FIG. 8,

w≧v—visible width of fields of raster of labels 2, on margins nearby to the edge and, if there is a wish, on butts of several adjacent sheets 3, of a book while a book block is bent in an interval of 0°-180° (this width is also designated as shading of a background on FIG. 2 and FIG. 6),

d—thickness of data carriers 1, being associated with sheets 3, of a book, which usually does not exceed thickness of a sheet “D”, or thickness of layer of paint used for drawing of labels 2, which usually may be neglected.

Using specified data, it is not difficult to detect, that:

the designated variables have such a correlation {[W/(P*D)]*D*[H/h]}≧l*m;

the maximum possible amount M of labels 2 in a row along fore-edge of a book (i.e. in a direction downward from top) corresponds to inequality M≦H/h;

the minimum necessary amount N of the said rows of labels 2, on fore-edge conforms to inequality N≧P/(H/h);

the minimum area s of fields of each label 2, is expressed by the equation s=h·v;

the area S of butt of a fore-edge is expressed by formula S=H*V≦H*W; and

the total area to be expended in a means according to the invention for placing of all labels 2, should conform to the inequality P*s≦S.

The above ratios let anybody skilled in the art, to design such a means according to the invention for search of pages in various books, which effectively meets the requirements of ergonomics, of aesthetics, of wear-resistant etc.

So, if a book block will not be subjected to bending, expense of area of data carrier 1, for placing of one of the most long label 2, should conform to the inequality s≦S/P=H*V/P. Then, in raster variant with use of butts of unbent sheets 3 only, as data carriers 1, no more than V/v of rows of labels 2 can be placed across fore-edge.

So, if a book block will not be bent, expense of area of data carrier 1, for placing of one longest label 2, should conform to the inequality s≦S/P=H*V/P. Then, in raster variant with use of only butts of unbent sheets 3, as data carriers 1, no more than V/v of rows of labels 2 can be placed across fore-edge.

Because the bending of a book block considerably increases visible width of a fore-edge, the area s of data carrier 1, spent for placing of one longest label 2, conforms to the inequality s≦H*W/P. Therefore in raster variant with use as data carriers 1, of margins nearby to the edge and, if there is a wish, of butts of several adjacent sheets 3, it permits to place from W/w up to W/v of rows of labels 2, across a fore-edge of a book.

Accordingly, a raster scheme of placing of labels 2, on butts of only unbent sheets 3, can be recommended then, when D*H/h≧l*m. This for example is possible in some children's reference books with thick cartoon sheets, which exclude a bending.

In view of above mentioned, it is obvious that in books, which permit a bending of book block, a raster scheme of placing of labels 2, on margins near edges and, if there is a wish, on butts of several adjacent sheets 3, has substantially greater prospects of practical use. It should be added here that in such a raster embodiment, the more bent a book block will be, the more recognizable the disappearing pictures of labels 2 will be, and that in result of excessive bending, white spaces can arise between raster bands, as shown on FIG. 2 and FIG. 6.

In comparison with raster variant, the using as data carriers 1, for placing of labels 2, only on margins near edges of some sheets 3, under local cuts placed like stair-steps in previous sheets 3, preferably alternated with local cuts in subsequent sheets 3 (FIGS. 10 and 23), is less practical.

Really, and in such a means according to the invention on a bent book block, width of a visible part of carriers 1, between nearby labels 2, in a horizontal row, as well as in raster variant, can conform to inequality (W/P)*(H/h)≧l*m. However reviewing of raster labels 2, requires neither local cuts in sheets 3, preceding to each of such label 2, nor of equipping of some of book sheets 3, with transparent insets in some separate parts of a book block. Therefore placing of labels 2, with use of such cuts or insets can be recommended only for those reference books, which are issuing at the typographic enterprises possessing appropriate equipment.

The specified inequality, (W/P)*(H/h)≧l*m, is most easily feasible by use of data carriers 1, being juts outside of lateral edge (fore-edge) of book sheets 3. This is the most preferable variant of a means according to the invention, which can be separately made and sold with instructions to the users for subsequent associating with the appropriate reference books; this is considered further on a concrete example of “English-Russian Dictionary” by V. K. Müller.

The 11-th stereotype edition of this dictionary, issued in 1964 by publishing house “Sovetskaja Enciklopedia” and widely spread in CIS, contains 70000 words and expressions on 1192 pages.

In a means for search of pages in a book, only a main corps of the dictionary and sections: “The list of names”, “The list of the geographical names” and “The list of the most widely used English abbreviations” were supplied by textual identifiers 4, of last entries (bottom key-words) of odd pages. But sheets of initial sections “Preface to the seventh edition”, “Lexicographical sources”, “About using of the dictionary”, “Phonetic & orthographic remarks”, “The list of reductions” and “The English alphabet” were not marked by labels 2.

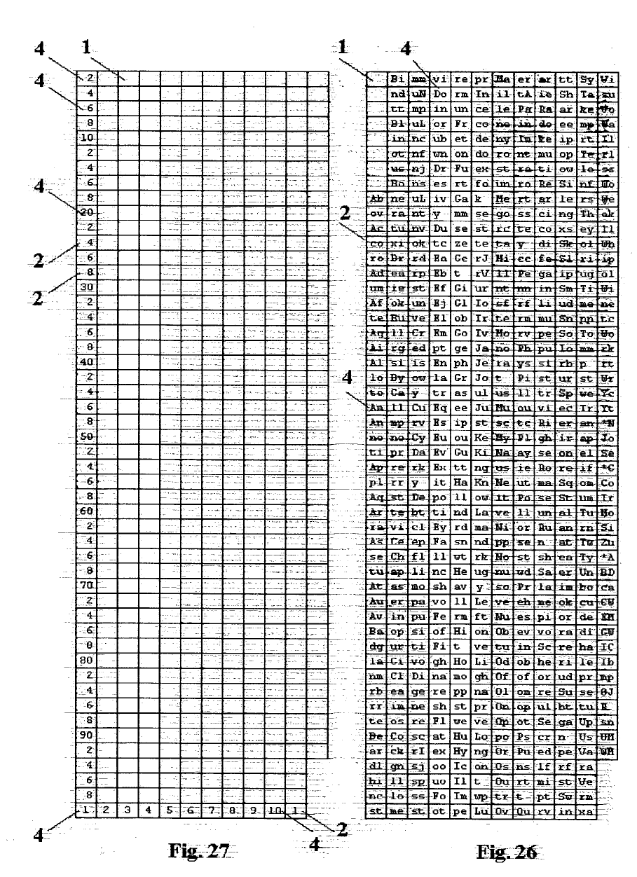

At designing and manufacturing of a real means according to the invention for this dictionary (see FIG. 26 and FIG. 27) by constant initial data were taken into account:

amount of sheets (and, practically, spreads), P=596;

height of a fore-edge H=250 mm;

thickness of sheets D=0,07 mm.

Because for equipping of the dictionary, a means for search of pages in a book on the basis of data carriers 1 in a form of tabs to be associated with sheets 3, was used, the minimum visible width of the fore-edge face of closed unbent book was not taken into account. Accordingly, the said values W1 and W2, of visible width of a fore-edge of closed book, at different modes of bending, were taken into account only from the point of view of visibility of labels 2 on said data carriers-tabs 1.

And at last, from the same consideration of visibility of labels 2, with regard to technical opportunities of embodiment of the inventive concept, there were chosen:

minimal height of fields for placing of labels 2, on data carriers-tabs 1, being associated with book sheets 3, h=5 mm (i.e. equal to height of upper-case graphemes of a font, a little larger than font of the main text of the book);

maximum width of graphemes of chosen font m=2,5 mm;

maximum amount of graphemes in labels 2, l=2 and

minimum width of fields for placing of labels 2, on data carriers-tabs 1, (i.e. in essence, width of these tabs with no attention to the size of additional parts, necessary for their fastening to sheets 3, of book) v=5 mm.

In the example of a real means, conditionally shown on FIG. 26 and FIG. 27 by semi-manufactured product been already assembled, onto data carriers-tabs 1, which after associating with sheets 3, of mentioned dictionaries are always located outside the fore-edge there were put:

on obverses (FIG. 26)—the literal-labels 2, which consist of parts of records of last key-words of entries of odd pages, which are partially visible when rigid top-cover is opened and are completely visible after bending of a book block; and

on rear sides (FIG. 27)—the digital labels 2, which consist of parts of records of even numbers of pages, which are partially visible on turned back book with opened rigid back cover, and are completely visible after bending of a book block.

Herewith as examples of textual and non-textual means for highlighting of labels 2, in such a real means for the concrete dictionary there were used:

a) for, mostly of two-letter labels 2 placed on obverses of data carriers 1, as shown on FIG. 26:

“gray background” and UPPER-CASE letter in the first position only, for each label 2, of initial (zero) hierarchical rank;

“white background” and lowercase letters only, for each label 2, of the next (first) hierarchical rank;

“White background” and UPPER-CASE letter in second field only, for each label 2, of the second (the last for this sample of a means) hierarchical rank;

“gray background” and both UPPER-CASE letters for labels 2, which in this specific example concern abbreviations in section “The list of the most widely used English abbreviations” only; and

combinations of a sign “*” in the first field with the UPPER-CASE letter in the second field, and of “an additional saturation of a background” of each label 2, for initial labels 2 of additional sections of the dictionary;

b) for mostly one-digit labels 2, (as shown on FIG. 27) on rear side of the same data carriers 1:

“a gray background” of labels 2 for tens of hundreds of pages and “a white background” of labels 2 for hundreds of pages,—in bottom row; and

“a gray background” of labels 2 for tens of pages and “a white background” of labels 2 for units of pages,—in the leftmost column.

While using of this real means, the textual identifiers 4, being read as it will be further described contain:

in a literal variant—from one up to three labels 2, and in sum of no more than six letters; and

in a digital variant—from one up to two labels 2, and in sum of not more than four digits.

In the example of a means, data carriers-tabs 1, being associated with each of 50 successive sheets 3, (or spreads) of a book, form in semi-manufactured products twelve vertical columns with 50 such carriers 1 per one column (except the last columns which may have 50 labels 2, excluding a few). Therefore in this example between nearby data carriers-tabs 1, in horizontal rows there are usually 50 sheets 3.

As the means for the specified dictionary was designed in standard decimal numeration, as shown on FIG. 27, consequently 50 successive digital labels 2 correspond to 100 successive pages. Herewith it turned out that, the digital labels 2, for highlighting of hundreds and thousands of pages it is enough to place at the only, in particular, at bottom horizontal row of data carriers-tabs 1. Then digital labels 2, which differentiate units and tens of pages and are located above the bottom row, can have a form of identical sequences of numbers, located in vertical columns of semi-manufactured products of specified carriers-tabs 1. That is why in example on FIG. 27 there is only one column with digits placed.

Users by themselves can divide assembled sheets of semi-manufactured products of described type into separate carriers 1, of labels 2, to associate carriers 1 with proper sheets 3, of any reference books according to instruction enclosed to such a purveyance and to receive required means.

Intelligibly, that after scission of semi-manufactured product and associating of data carriers-tabs 1, with the book sheets 3, the differential labels 2, will be located as stair-steps along fore-edge. Accordingly, the specified carriers-tabs 1, will be transformed into markers of pages 3, directly visible when the book is closed (see FIG. 22). Therefore by such a means it is possible to equip the books which have from tens up to many thousands of sheets.

By the way, for the information: in the closed dictionary, according to an example, total width of only butts of 50 sheets is equal to 3,5 mm. While bending up to 90° when said butts and adjoining to them parts of margins of pages are becoming visible, the allowable width of labels 2 can reach 13 mm and, while bending up to 180° they may reach about 25 mm. These sizes are quite sufficient for using in the specified dictionary of the raster and other variants of a means according to the invention.

And, to conclude the description of a real example, it should be noted that such a combined means, with literal and digital identification of sheets 3, of reference book, is neither solely possible, nor especially preferable. So for the bilingual dictionaries, for telephone directories and commodity catalogues or price-lists, and for a number of other reference books not equipped with alphabetic subject indexes and references to page numbers, on both sides of data carriers 1, it's expedient to put only literal-labels 2. And vice versa for reference books equipped with such indexes on both sides of data carriers 1, it may be as most preferable to put only digital labels 2.

Below, essence of the invention is additionally explained by demonstration examples for two types of a means according to the invention:

a) with literal identifiers according to FIG. 14 and FIG. 16-18, and right parts of FIG. 22-24, and

b) with digital identifiers according to FIG. 5-8 and left-parts of FIG. 22-24.

In these examples among means of highlighting of textual labels 2, in a structure of as well textual identifiers 4, there are shown:

UPPERCASE letter in the first field of each label 2, of initial (zero) hierarchical rank;

only lower-case letters in each label 2, of the first hierarchical ranks;

Lowercase italic in each label 2, of the second hierarchical ranks; and

Underlined lower-case italic in each label 2, of the third hierarchical ranks.

The specified ranks can be designated and by “key” digits “0”, “1”, “2” and “3”, as it is visible in a leftmost column on FIG. 3. Such a digital highlighting of hierarchical ranks of literal-labels 2, is desirable to apply only for training of how to use a means according to the invention. Herewith is obviously, that both digital and any other textual and/or non-textual means, chosen from above described group for highlighting of literal-labels 2 should be identical in main part of a means and in right column of an educational example, which is similar to shown on FIG. 3.

From comparison of digits of leftmost and right columns on FIG. 3 as applied to demonstrative examples, shown on FIG. 1-4 and FIG. 16-18 and right parts of FIG. 22-24 it is clearly that if one- and two-literal labels 2, have:

the top (“zero”) hierarchical rank, then they can be or as directly read elementary textual identifiers 4, or as beginning of longer textual identifiers 4;

the first hierarchical rank, then they can be as parts of such textual identifiers 4 which consist at least of two labels 2 and should be read together with labels 2, directly previous to them of zero hierarchical ranks;

the second hierarchical rank, then they can be as parts of such textual identifiers 4 which consist of at least of three labels 2 and should be read together with labels 2, directly previous to them of zero and first hierarchical rank;

the third hierarchical rank, then they can be as parts of such textual identifiers 4 which consist at least of four labels 2 and should be read together with labels 2, directly previous to them of zero, first and second hierarchical ranks, and so on.

Similarly, in digital demonstrative examples (see FIG. 5-6 and only informative FIG. 7, and also left parts of FIG. 22-24); the key of recognition of hierarchical ranks of one-digital labels 2, is indicated in the top row on FIG. 8. These ranks in the given example with one-digital labels 2 coincide with numbers of fields of digits, used in page numbers.

In a specified key for maximal page numbers of a four digits on FIG. 8 the digital indexes of highlighting of all ranks of labels 2, are shown together with chosen for given case, also only as an example, as some non-textual means which have been used on FIGS. 5 and 6 namely:

the index “3” conforms to rank of units (and in the page numbers, only on FIG. 8 additionally is highlighted “by the shading of background”);

the index “2” conforms to rank of tens and is highlighted “by full frame”;

the index “1” conforms to rank of hundreds and is highlighted “by black background in rectangle”; and

the index “0” designates the rank of thousands and is highlighted “by black background in circle”.

Note, that such a specific digital indexes unified for both examples of textual (both digital and literal) identifiers 4 are used here only for simplification of perception of variants of embodiments of the inventive concept, and they are absolutely optional at other practical variants of its realization.

The specific features of digital identification of reference books' sheets 3 (in a described most preferable example of realization of the inventive concept according to FIG. 5-8) in comparison with literal identification consist in the following:

(1) each digital label 2, placed on a data carrier 1, being associated with a certain book sheet 3, is highlighted according to its position in a page number of proper even or odd page;

(2) each digital identifier 4 always determines a page number of certain even or odd page of a certain sheet 3 or spread;

(3) irrespective of how really a means according to the invention is made (in particular, to show only even as in a considered example or only odd or even and odd page numbers), any well-ordered multitude of digital identifiers 4 associated with identical type of sides of book sheets or spreads, represents by themselves a monotonous increasing sequence (as a rule by step of “2”) of page numbers;

(4) the zeroes in digital labels 2 usually are not used, for at indicating the ranks of each digit distinct from zero in adjacent digital identifiers 4, cumulative considerations of several of successive digital labels 2 allow the user easily to restore complete digital identifiers 4 and thus numbers of appropriate pages.

The first above mentioned feature means that each digital label 2, of example of means according to the invention consists only of one grapheme.

The second said feature means that amount of digital labels 2, of which digital identifiers 4, of example of a means according to the invention can consist, is in range from unit up to maximum possible amount of digits in the greatest page number of the specific reference book.

The third above mentioned feature demands to consider an image on FIG. 8 as such a fragment which is included in mentioned sequence of previous and subsequent page numbers not shown conditionally.

The fourth above mentioned feature is not the absolute ban. Really, the digital identifier 4 which specify page number “2002”, in the third row from top on FIG. 8, can be definite in two ways, namely:

or by digital label 2, “2” which conforms to a rank of units and that's why is highlighted in a left column on FIG. 7 by a digital index “3”, and on FIG. 5 “by the shading of background”;

or by digital label 2 “0”, which conforms to rank of hundreds, as shown on FIG. 6.

Therefore on “educational” FIG. 7 the leftmost column does not contain all possible set of digital indexes of ranks of digital labels 2 of the rightmost column and serves only for additional demonstration of conformity of labels 2 on FIG. 5 and of identical digital labels 2 in digital identifiers 4 which represent page numbers shown on FIG. 8.

It's evident that the described example of a means for the specified English-Russian Dictionary and, these demo examples by no means exhaust or limit scope of highlighting of labels 2, but play a role only of some of multitude of possible illustrations of feasibility of inventive concept.

So, in real means of a described type for highlighting of any labels 2 and, in particular, for a designation of their hierarchical ranks in textual identifiers 4, not only allographs of graphemes and, monochrome background saturation can be used but various colors, frames and any other of above mentioned textual and non-textual means as well.

Further, the quantity of hierarchical ranks of textual labels 2 and, accordingly, maximum amount of such labels 2 in a structure of textual identifiers 4 can be less or more than four.

However it does not influence a principle of using a means for search of pages.

In a general case, i.e. irrespective of the particular form of embodiment of inventive conception the described means is used for search of pages in such a way.

In the beginning, each user studies the instruction, in which there are specified:

a type of the data carriers 1 used in a real means;

a type (digital or literal) of labels 2 and of textual and/or non-textual means of their highlighting, among them in a search procedure a special role belong to those means which represent hierarchical ranks of separate labels 2, in textual identifiers 4; and

rules of reading of textual identifiers 4, and of choice of book sheets 3, which are highlighted by them.

Then, while bending of whole (see FIGS. 19 and 20) or of essential part (usually of about half as on FIG. 21) of book block, they open for the review a necessary part of a means, choosing an angle of a bend in an interval from 0° up to nearly 180° depending on flexibility of sheets and of others above said parameters of the book.

Such a bend for thin wide sheets 3, especially with flexible covers may be easily reached manually. In case of rigid covers the sheets 3 are curving by pressing on spine of a book near cover and/or by turning spine with a cover up to desired angle. A bend of different, more often approximately of equal parts, although, while clamping of the backbone by cramp, and of any of parts of a book block toward any side if using of supports under backbone, or under sheets 3, or under own weight of sheets, is also possible.

By bending a book block into one for example right side, they make opened for the simultaneous review a part (in the example with the dictionary and, on the drawings of literal-labels 2 only, see right parts of FIG. 22-24 and FIG. 26) of textual labels 2, on obverse of data carriers 1, (see right parts of FIG. 22-24 and FIG. 26). Analogously, by bending a book block into opposite side, they open for simultaneous review the other part of textual labels 2, (in the example with the dictionary and on the drawings, of the digital labels 2 only, see left parts of FIG. 22-24 and FIG. 27). Intelligibly, that any non-raster textual labels 2 located on different sides of the same data carrier 1 correspond to same sheets 3, of books.

Further, they train themselves m recognition by eye or to the touch of hierarchical ranks of labels 2, and in reading of thesauri, which are enabling mentally to form textual identifiers 4, and to use them for choice of relevant sheets 3.

After doing of described training the user of a means according to the invention can be freely oriented in structured multitude of textual labels 2 or, what is same, in AND-OR tree of letters of textual identifiers 4, (see FIG. 4), as well as in sequences of digital labels 2.

To the user it will be clearly that at literal identification, the literal label which has zero hierarchical rank and consists of the only grapheme “I”, has no “subordinated” labels 2, and by itself serves as textual identifier 4, which points to a definite sheet 3, of reference book.

Further not less clearly, that the two-letter label 2 “In” of the same zero rank has four “subordinated labels” 2-“te”, “r”, “rn” and “et”. From all these labels 2, they can mentally assemble such different textual identifiers 4, which are associated with different book sheets 3, as:

textual identifier 4 “In” consisting of the only label 2;

textual identifier 4 “Inte” consisting of two labels 2;

two textual identifiers 4 “Inter” and “Intern”, each of three labels 2; and

one textual identifier 4 “Internet”, which consists of four labels 2.

Analogously, three textual identifiers 4 “Ir” “Iren” and “Is” can be mentally formed in process of visual or tactile perception of AND-OR tree of labels 2.

The initial labels 2, of zero rank together with the pointing final labels 2, of any other hierarchical ranks in each of specified in this example and in any of similar arbitrary textual identifiers 4, will specify direct access to quite definite sheets 3, of books.

Naturally, a lot of another words can exist in intervals between words represented by adjacent textual identifiers 4, in real dictionary or in another reference book. The words which include according to FIG. 4 such rows of graphemes as: “Intend” “Internal” and “Ira” which are not the textual identifiers can be as such examples. Therefore the accuracy of access to a desired word or entry of textual record with help of a means according to the invention usually lies within ±1 sheet.

Rules of perusal of digital identifiers 4, of pages of reference books are usually simpler, than similar rules for literal identifiers 4.

For example, the perusal of digital identifier 4, which specifies the last (conditionally framed) page number “2016” on FIG. 8, consists in the next:

by using non-textual means of highlighting “a black background in a circle” they choose among previous digital labels 2 a nearest label 2 “2” which conforms to the rank of thousands (visible in the second row from top on FIG. 5-8);

beneath specified row, by using non-textual means of highlighting “a black background in a rectangle” they choose from previous digital labels 2 a nearest label 2 “0” which conforms to the rank of hundreds (visible in the third row from top on FIG. 6 and FIG. 8);

still beneath, by using non-textual means of highlighting “the full frame with shading of background” they choose from previous digital labels 2 a nearest label 2 “1” which conforms to the rank of tens (visible in the fourth row from bottom on FIG. 5, FIG. 6 and FIG. 8);

and at last from following digital labels 2; they choose such not highlighted specially nearest label 2 “6” which conforms to the rank of units (visible in the bottom row on FIG. 5-8). In result mentally concatenate a digital identifier 4 which gives an access toward the page with proper page number “2016”.

Thus a means similar to ones shown on FIG. 22-24 and FIG. 26-27 permit directly to read labels 2, to concatenate them and to choose suitable textual identifiers 4, to press down a necessary marker on edges of flabby sheets 3, and to divide a batch of sheets 3, between necessary adjoining pages with an error, as a rule, within not more than ±1 sheet 3.

### INDUSTRIAL APPLICABILITY

The offered means for fast search of pages in a closed book, is rather simple, and can be produced on the modern printing equipment while issuing of any ordinary editions and reference books.

The most widely, simply and in a cheapest way while manufacturing it can be used if placing labels on tabs of sheets of reference books, because in such cases the equipping of books by a means according to the invention is possible even after issuing and putting books onto sale.

Experimentation with a means according to the invention showed, that a steady skill of choice of necessary adjoining pages or spreads may be reached by readers in a few minutes or during up to half an hour.

1. A means for search of pages in a book includes:
data carriers being visible when the book is closed and associated with pages of said book, and
textual identifiers of contents of records of identical type of pages of sheets or spreads which consist of non-empty multitude of labels hierarchically ordered and placed over the said carriers each of at least one grapheme,
wherein
in the structure of the said means
each label, except the first label, contains at least one grapheme which distinguishes the textual identifier of a current marked sheet from the textual identifier of the previous marked sheet;
each textual identifier contains initial and final label, highlighted by a suitable means;
the initial label of each textual identifier is placed over data carrier associated with that sheet of the book where the text record begins with the said label;
the final label of each textual identifier is placed over the data carrier associated with that sheet of the book where the text record begins with the said identifier;
position of each label in hierarchy of labels of each current textual identifier is highlighted by at least one of suitable means; and
labels of identical hierarchical rank in adjacent textual identifiers are highlighted by identical suitable means.

2. A means as defined in claim 1 wherein
the suitable means for highlighting labels is an easily distinguishable by eye or by skin textual or non-textual means selected from a group which consists of:
allographs of graphemes used in structure of labels;
a color, or saturation of color of graphemes, used in structure of labels;
full or partial frame around the separate graphemes inside the labels and/or around the separate labels as a whole;
position of separate grapheme in structure of labels and/or separate label in the structure of the textual identifiers;
numbers of hierarchical ranks of separate labels in the structure of the textual identifiers;
a color or saturation of color or of a geometrical form or texture of the data carriers, associated with sheets of the book; and
arbitrary combinations of at least two specified means.

3. A means as defined in claims 1 or 2 wherein
the data carriers, associated with the book sheets, are selected from a group consisting of:
a) parts of the book sheets which are free from main text and are:
margins of pages being at least partially visible to user while bending the sheets; or
butts of sheets at the head, tail, and fore edge of the said book; and
combinations of the said margins and butts of sheets;
b) tabs of suitable form, which are located outside the edge of the book sheets, with labels placed over them and which represent:
either parts of book sheets,
or additional details of suitable material, attachable to the book sheets.

4. A means as defined in claims 1 or 3 wherein
an initial and a final data carriers in the structure of the said means are associated with proper sheets of the book in approximately middle part of edges of these sheets.

5. A means as defined in claims 1 or 2 or 3 wherein
only page margins adjoining to the edges of sheets are used as data carriers and at least two raster labels are put over each of them on different distances from the edge.
